(19) United States
(12) Patent Application Publication
(10) Pub. No.: US 2019/0173823 A1
(43) Pub. Date: Jun. 6, 2019

(54) LOCATION-BASED GROUP DISCOVERY FOR MESSAGING APPLICATIONS

(71) Applicant: Microsoft Technology Licensing, LLC, Redmond, WA (US)

(72) Inventors: Abhinav Mukherjee, Hyderabad (IN); Shantanu Prasade, Hyderabad (IN); Manav Mithal, Hyderabad (IN); Vani Sivasankar, Hyderabad (IN); Saumitra Agarwal, Hyderabad (IN); Jayram Kumar, Hyderabad (IN); Ravi Birhman, Hyderabad (IN); Andre Rodrigues, Hyderabad (IN); Rajiv Kumar, Hyderabad (IN); Prashant Gupta, Hyderabad (IN); Deepak Pratinidhi, Hyderabad (IN); Rakesh Midha, Hyderabad (IN); Arun Rajappa, Hyderabad (IN)

(21) Appl. No.: 15/877,131

(22) Filed: Jan. 22, 2018

(30) Foreign Application Priority Data
Dec. 4, 2017 (IN) 201741043437

(51) Int. Cl. H04L 12/58; H04W 4/029

(52) U.S. Cl. CPC H04L 51/20; H04W 4/029; H04L 51/38; H04L 51/32

(57) ABSTRACT

In non-limiting examples of the present disclosure, systems, methods and devices for surfacing one or more location-based messaging groups are presented. Geolocation information associated with a current location of a client computing device may be sent to a group messaging service. A request to identify one or more location-based messaging groups corresponding to the current location of the client computing device may be sent from a group messaging application to the group messaging service. Information associated with one or more location-based messaging groups for which the current location of the client computing device meets a location-based threshold may be received from the group messaging service, and the one or more location-based messaging groups for which the current location of the client computing device meets the location-based surfacing threshold may be surface on a display of the client computing device.

### CROSS REFERENCE TO RELATED APPLICATIONS

This application claims priority to and benefit from provisional Indian Patent Application No. 201741043437, filed on Dec. 4, 2017, by the same title, which is expressly incorporated by reference herein.

### BACKGROUND

Group messaging applications provide convenient mechanisms for users of those applications to communicate with one another. Group messaging applications have become increasingly popular, not only for informal group communications, but also in the workplace. While the ease and convenience associated with group messaging communications is evidenced by the rise in popularity of group messaging applications, an application user typically must obtain one or more pieces of contact information (e.g., a phone number, an application alias, etc.) associated with a second application user that they would like to communicate with before they can initiate a conversation with that second application user.

It is with respect to this general technical environment that aspects of the present technology disclosed herein have been contemplated. Furthermore, although a general environment has been discussed, it should be understood that the examples described herein should not be limited to the general environment identified in the background.

### SUMMARY

This summary is provided to introduce a selection of concepts in a simplified form that are further described below in the Detailed Description section. This summary is not intended to identify key features or essential features of the claimed subject matter, nor is it intended to be used as an aid in determining the scope of the claimed subject matter. Additional aspects, features, and/or advantages of examples will be set forth in part in the description which follows and, in part, will be apparent from the description or may be learned by practice of the disclosure.

Non-limiting examples of the present disclosure describe systems, methods and devices for surfacing one or more location-based messaging groups. In some examples, a method for surfacing one or more location-based messaging groups may be provided, the method comprising: sending geolocation information associated with a current location of a client computing device to a group messaging service; sending, from a group messaging application to the group messaging service, a request to identify one or more location-based messaging groups corresponding to the current location of the client computing device; receiving, from the group messaging service, information associated with one or more location-based messaging groups for which the current location of the client computing device meets a location-based surfacing threshold; and surfacing, on a display of the client computing device, the one or more location-based messaging groups for which the current location of the client computing device meets the location-based surfacing threshold.

In other examples, a system for causing one or more location-based messaging groups to be surfaced may be provided, the system comprising: a memory for storing executable program code; and one or more processors, functionally coupled to the memory, the one or more processors being responsive to computer-executable instructions contained in the program code and operative to: receive, from a group messaging application executed on a client computing device, a request to surface one or more location-based messaging groups; receive geolocation information associated with a current location of the client computing device; identify, based on the received geolocation information, one or more location-based messaging groups for which the current location of the client computing device meets a location-based surfacing threshold; send, to the client computing device, information associated with the identified one or more location-based messaging groups; and cause the identified one or more location-based messaging groups to be surfaced in a user interface of the group messaging application.

### BRIEF DESCRIPTION OF THE DRAWINGS

Non-limiting and non-exhaustive examples are described with reference to the following figures:

FIG. 1 is a schematic diagram illustrating an example distributed computing environment for surfacing one or more group messaging application location-based groups on a client computing device, joinable based on a user being with a geographical threshold distance of one or more group locations.

FIG. 2 illustrates an exemplary user interface for creating a location-based group on a group messaging application.

FIG. 3 is a generalized diagram illustrating a user of a group messaging application in relation to a plurality of location-based groups of the group messaging application, each of which may be joinable by the user based on a determined distance of the user from each group location and the discoverability range associated with each group.

FIG. 4A is an exemplary method 400A for surfacing one or more location-based messaging groups in a group messaging application.

FIG. 4B is an exemplary method 400B for causing one or more location-based messaging groups to be surfaced in a group messaging application.

FIG. 5 is a schematic diagram illustrating exemplary components of a distributed computing environment for creating location-based messaging groups for a group messaging application and causing location-based messaging groups to be surfaced based on a user's proximity to each group location and the discoverability range associated with each group.

FIGS. 6 and 7 are simplified diagrams of a mobile computing device with which aspects of the disclosure may be practiced.

FIG. 8 is a block diagram illustrating example physical components of a computing device with which aspects of the disclosure may be practiced.

FIG. 9 is a simplified block diagram of a distributed computing system in which aspects of the present disclosure may be practiced.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

The various embodiments and examples described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the claims.

Generally, the present disclosure is directed to systems, methods and devices for creating location-based groups accessible to users of a group messaging application, and causing location-based groups to be surfaced on a requesting computing device based on a requesting user's client computing device being within a discoverability range of one or more location-based groups. In examples, a margin of error for the current location of the client computing device may be factored into a determination of whether a requesting client computing device is within a discoverability range of each of the one or more location-based groups.

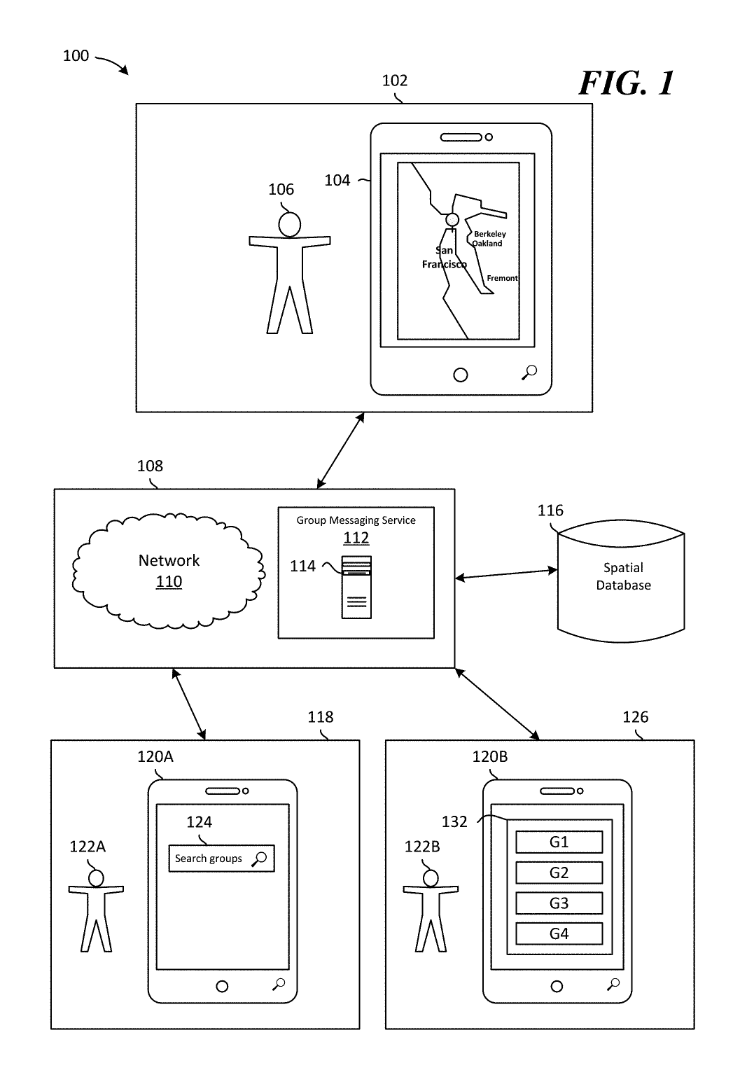

FIG. 1 is a schematic diagram illustrating an example distributed computing environment 100 for surfacing one or more group messaging application location-based groups on a client computing device, joinable based on a user being within a geographical threshold distance of one or more group locations. Distributed computing environment 100 includes location-based group creation sub-environment 102, network and processing sub-environment 108, spatial database 116, group request sub-environment 118, and group surfacing sub-environment 126.

Location-based group creation sub-environment 102 includes group messaging application user 106 and computing device 104. User 106 may access a group messaging application via computing device 104 and create a location-based group in the application, which may be accessible by one or more other users of the group messaging application. In this specific example, user 106 has created a location-based group in the San Francisco Bay Area, with a specific location indicated on the display of computing device 104 with a pin on the northern end of the San Francisco Peninsula shown on the user interface of the group messaging application on computing device 104.

In some examples, to mark a location as a location-based group, user 106 may drop a pin on a map provided by the group messaging application where user 106 would like to create the location-based group. In other examples, user 106 may enter an address into the group messaging application corresponding to the location where user 106 would like to create the location-based group. In still other examples, user 106 may enter a zip code, a city name, ISD code, STD code, phone number, or other geographic indicator corresponding to the location where user 106 would like to create a location-based group.

In some examples, the group messaging service 112 may comprise a plurality of geocoordinate keys, each of which may be associated with one or more location-based groups. In examples, when a user, such as user 106, would like to create a location-based group, that user may enter at least one geographic indicator (e.g., a city name, a postal code, etc.), which may be associated with a defined geographic region comprised in a geo-mapping service comprised in the group messaging service 112. In additional examples, the geo-mapping service may be comprised in a remote geo-mapping service, which the group messaging service 112 may communicate with, via network 110, to obtain the defined geographic region corresponding to a geographic indicator included in a request to create a location-based group.

In some examples, when a user creates a group utilizing the pin drop mechanism described above, the group messaging service 112, in association with a geolocation service, may determine geo-location coordinates (e.g., longitude and latitude coordinates) corresponding to the pin's drop location in the map that the creating user is utilizing, via the group-messaging application, to create the location-based group. In examples, the geolocation service may be comprised as part of group messaging service 112, or separate from the group messaging service 112. The group messaging service 112, alone or in association with a geolocation service, may convert determined geo-location coordinates associated with a dropped pin to one or more geographic indicators. For example, if user 106 is creating a location-based group via interaction with the map depicted on the display of computing device 104, the pin may be dropped as indicated in the location-based group's desired location, and geo-location coordinates associated with the location of that pin may be determined by group messaging service 112.

In a specific example related to FIG. 1, geo-location coordinates of (latitude 37.776775, longitude −122.416626) for the location of the pin dropped by user 106 may be determined by group messaging service 112. Upon determining the geo-location coordinates corresponding to the location of the dropped pin, group messaging service may make a determination as to one or more geographic indicators related to those coordinates. For example, group messaging service 112, in association with a geo-mapping service, may determine that the determined geo-location coordinates for the dropped pin of (latitude 37.776775, longitude −122.416626) correspond to an address (i.e., 1355 Market Street, San Francisco, Calif. 94103) which comprises geographic indicators including: Building (Mid-Market landmark building); Postal Code (94103); City (San Francisco); Country (United States); Neighborhood (South of Market). Thus, in some examples, when user 106 drops the pin on the map displayed by computing device 104, user 106 may access a user interface via computing device 104 including each determined geographic indicator corresponding to the dropped pin, which user 106 may interact with to restrict joinable access to the location-based group being created at that location.

In restricting joinable access to the location-based group being created, user 106 may select, via a graphical user interface of the group-messaging application, one or more of the determined geographic indicators corresponding to the dropped pin's location. Thus, user 106 may indicate via the graphical user interface displaying the determined geographic indicators corresponding to the pin's location in the group messaging application, that only those users that are determined to be at a location comprised in a geographic region corresponding to one or more of the determined geographic indicators selected by user 106, may join the location-based group created by user 106. In some examples, upon receiving a selection of the one or more geographic indicators corresponding to the pin's location, the group messaging service may associate each selected geographic indicator with a group ID for the location-based group being created, which may be utilized in determining whether users seeking to join a group have a location that matches the region associated with the geographic indicator and its corresponding group ID.

In one example, if user 106 selects only geographic indicator Building—Mid-Market landmark building—only those users determined to be located at that location, or a set radius from that location as indicated in the creation of the location-based group by user 106, may be able to join the location-based group. In another example, if a user 106 selects only geographic indicator Neighborhood—South of Market—user 106 may so indicate that only those users determined to be located in the geographic region corresponding to that neighborhood may be able to join the location-based group. In another example, if user 106 selects only geographic indicator Neighborhood—South of Market—user 106 may be provided with an option to select a distance from the geographic boundaries of that selected geographic indicator such that only those users determined to be located in the geographic region corresponding to the selected neighborhood and those users determined to be located within the selected distance from the geographic boundary of that selected neighborhood, may join the location-based group.

In addition to providing the group messaging application with a location where user 106 would like to create a location-based group, user 106 may also enter a distance from that location in which the location-based group will be discoverable to other users of the group messaging application. A discoverable range may thus be set by user 106. For example, user 106 may indicate that a location-based group being created have a 100-meter, 1-mile, 5-mile, 10-mile, etc. radial distance from the indicated location of the group being created in which other users of the group messaging application may discover the group in the group messaging application upon entering within the specified discoverable range. In additional examples, a user may set the discoverable range of a location-based group by selecting one or more geographical indicators (e.g., a city name, a name of a neighborhood, a zip code, etc.) and/or a discoverable range from a boundary of a geographical region associated with a geographical indicator, as discussed more fully above. In such an example, the discoverable range for the corresponding location-based group may comprise the outer bounds associated with the geographical indicator, with the location of the group being within that boundary. In other examples, the discoverable range for the corresponding location-based group may comprise a selected distance from the geographic boundaries of a selected geographic indicator (e.g., the geographic boundaries corresponding to a selected city plus 1-mile, the geographic boundaries of a selected neighborhood plus 500 meters, etc.). Thus, the discoverable range for a location-based group need not necessarily be a radial distance from the location of a group, but may also be a non-uniform boundary around the group location corresponding to a selected geographical indicator.

In addition to providing the group messaging application with a location and a discoverable range for a location-based group being created, user 106 may provide the group messaging application with a duration for which the group being created will be actively discoverable by other group messaging application users. For example, user 106 may make the location-based group for the location indicated by the pin on computing device 104 discoverable indefinitely, or a shorter period of time, such as one hour, one day, one month, etc. Upon a set discoverable duration for a location-based group expiring, it will no longer be discoverable to other users of the group messaging application. In some examples, if one or more users have joined a location-based group and the discoverable duration for that group subsequently expires, the one or more users may nonetheless continue to correspond with one another in relation to the location-based group messaging thread. In other examples, if one or more users have joined a location-based group and the discoverable duration for that group subsequently expires, the location-based group may no longer be available for messaging for the one or more users (i.e., the location-based group expires).

In some examples, location-based groups may be automatically created for a plurality of locations of similar type based on a single request to create a location-based group on the group messaging application. For example, an administrator of a distributed organization (e.g., a restaurant chain, a chain of retail stores, etc.) may make a single request to create a location-based group, but that request may be applied to create a location-based group at each physical location associated with the organization, or each physical location of the organization that is of a same type designated in the request.

The information input by user 106 to the group messaging application to create a location-based group may be provided to one or more computing devices associated with network and processing sub-environment 108 via network 110. For example, the information input into computing device 104, via the group-messaging application, by user 106 to create the location-based group in the San Francisco Bay Area may be sent to a computing device associated with a group messaging service 112, such as server computing device 114. Group messaging service 112, and associated server computing device 114, may perform operations related to creating location-based groups based on user input to create such groups, and making those groups discoverable to other users of the group messaging application upon receiving an indication that a user of the group messaging application is within a discoverable range, or within a geographic region/boundary corresponding to a selected geographic indicator, of a location-based group that has been created. Group messaging service 112 may perform additional operations related to causing one or more location-based groups to be surfaced on a group messaging application user interface displayed on a display of a requesting computing device, such as requesting computing device 120A and 120B, which are the same computing device illustrated at separate times in the surfacing mechanisms described herein.

Group request sub-environment 118 includes requesting user 122A and requesting computing device 120A, on which a generalized group messaging user interface is shown. The generalized group messaging user interface of computing device 120A comprises a search element 124 which requesting user 122A may utilize to input a request to surface location-based groups for which user 122A (i.e., user 122A's requesting computing device 120A) meets the discoverable range threshold for. In some examples, the group messaging application may automatically request that location-based groups, for which a requesting computing device meets a discoverable range threshold for, be surfaced in the group messaging application user interface of the requesting computing device. Thus, in some examples, a user may manually provide a request to surface available location-based groups to the group messaging application (e.g., a manual request via search element 124), and in other examples, no manual input is necessary as the group messaging application may automatically request the surfacing of available location-based groups on a periodic basis. In additional examples, one or more geographic indicators corresponding to a requesting device's location (e.g., a city corresponding to a requesting device's location, a neighborhood corresponding to a requesting device's location, a postal code corresponding to a requesting device's location, etc.) may be determined by group messaging service 112 as more fully described above, and those one or more geographic indicators may be surfaced on the display of a requesting device's user interface for selection. Upon selecting one or more displayed geographic indicators corresponding to the requesting device's location, a request may be sent to the group messaging service 112 to cause only those location-based groups that are currently active in the selected region to the requesting device.

Upon a request to surface available location-based groups being input into the group messaging application and/or a request to surface available location based groups being automatically generated by the group messaging application, that request may be sent from the requesting computing device 120A to the group messaging service 112 via network 110. In examples, the request to surface available location-based groups may include one or more location indicators of a geographic location of the requesting computing device 120A. In some examples, the one or more indicators may comprise longitude and latitude coordinates of the requesting computing device 120A. In some examples, the one or more location indicators may be determined based on GPS-enabled components of the requesting computing device 102A and one or more GPS services associated with the requesting computing device 102A. In additional examples, the one or more location indicators may be determined based on an IP address of a router or other computing device being utilized by the requesting computing device. In other examples, the one or more location indicators may be determined by triangulation of the requesting computing device 120A via a plurality of cellular network hubs.

In some examples, upon receiving a request to surface available location-based groups from requesting computing device 120A, group messaging service 112 may make a determination as to the geographic location of the requesting computing device 120A as provided by the one or more location indicators provided in the request. Group messaging service 112 may then analyze information associated with one or more active location-based groups to determine whether the location of the requesting computing device 120A is within a discoverability range of any of the one or more location-based groups that group messaging service 112 analyzes the information for. More specifically, the group messaging service may calculate or otherwise determine the distance between the requesting computing device 120A and one or more active location-based groups, and further determine whether that distance is less than the radius corresponding to the discoverability range for each of the one or more active location-based groups. In some examples, a margin of error corresponding to the relative accuracy of the current location of the requesting client computing device may be factored into this determination.

According to additional examples, when a request to surface available location-based groups has been received by group messaging service 112, one or more geographic indicators corresponding to determined geographic coordinates (e.g., longitude and latitude coordinates) of the requesting device may be determined. For example, geographic indicators comprising: a country, a city, a postal code, a neighborhood, a building, etc., corresponding to the requesting device's geographic coordinates, may be determined by group messaging service 112 via communication with a geo-mapping service. As such, group messaging service 112 may associate each geographic region corresponding to a geographic indicator for which a requesting device's geographic coordinates are determined to correspond to, and utilize that association in determining which joinable groups to provide to the requesting device. Thus, in an example where location-based groups have been created based on geographic indicators, information associated with those groups may be maintained by group messaging service 112 for matching against the determined geographic indicators determined for a requesting device's location. For example, if location-based groups have been created based on geographic indicators for group1, group 2, group 3, and group 4, each of those groups may be associated with a geocoordinate key corresponding to one or more geographic indicator, in group messaging service 112, as shown below.

Group ID—Group 1; Geocoordinate Key—City (San Francisco)

Group ID—Group 2, Group 3, Group 4; Geocoordinate Key—Postal Code (94103)

Thus, when geographic indicators corresponding to a requesting device's location are determined, group messaging service 112 may match those determined geographic indicators of the requesting device with the geocoordinate key, and group information for location-based groups that are currently active, in determining which joinable groups to provide to the requesting device. Likewise, a user of a requesting device may utilize the group-messaging application to restrict the joinable groups that will be surfaced in the application as being joinable, based on the selection of one or more geographic indicators corresponding to the requesting device's determined location (e.g., only show active groups that are in a geographical region of a city corresponding to the device's location, only show groups that are within a geographical region defined by a postal code corresponding to the device's location, etc.).

In some examples, only those location-based groups that are currently active on the group messaging application that are within a same region as the requesting computing device 120A may be analyzed in responding to the request. That is, due to processing costs and the time involved with analyzing information associated with all of the active location-based groups on the group messaging application, and further determining based on that analysis whether the requesting computing device 120A is within a discoverability range for each of those location-based groups, the group messaging service 112 may identify a subset of the active location-based groups to analyze and determine a distance between each group in that subset and the requesting computing device 120A. In some examples, the subset of location-based groups that are analyzed may comprise the active location-based groups that are within a determined same geographic indicator (e.g., city region, a state region, postal code region, neighborhood region, country region, etc.) as the location of the requesting group communication device 120A. In other examples, the subset of location-based groups may comprise the active location-based groups that are within a same region as a region associated with a registered account for the instance of the group messaging application being executed on the requesting computing device 120A. In still other examples, all of the active location-based groups may be analyzed rather than limiting that analysis to a subset based on region.

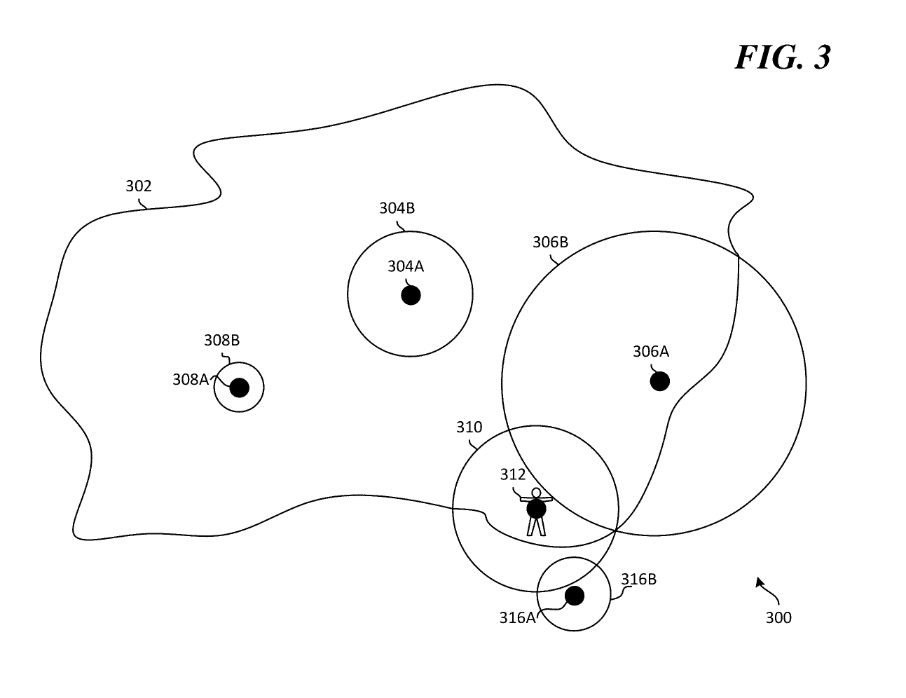

Although significant gains have been made related to accurately detecting the location of computing devices, there still remains a reasonable margin of error in at least some scenarios due to one or more factors associated with a particular device and/or location of a particular device, as well as certain network issues. As such, in determining whether a requesting device, such as requesting computing device 120A, is within a discoverability range of a location-based group, potential inaccuracy of the current location of the requesting computing device may be factored in that calculation. Thus, the specific location of a requesting device may be broadened to encompass a wider area (i.e., a region comprising the approximate location of the requesting device) than just the actual location determined based on the exact longitude and latitude information provided in a request by the requesting device. As such, when a request to surface one or more active location-based groups is received by group messaging service 112, the following query may be processed by the group messaging service 112 to determine whether the requesting computing device is within a discoverability range of a location-based group: “Execute (Get all entities meeting criterion Distance(point(userLocatoin), Point(GroupLocation))<RADIUS+Accuracy))”. In determining how large of a value to include for the Accuracy variable, one or more accuracy indicators associated with a device's location may be analyzed. For example, group messaging service may analyze one or more of: the battery status of a requesting device, the GPS status of a requesting device, the cellular connectivity status of a requesting device, and determine based on one or more of those analyzed indicators, how large or small of a value to include for the accuracy variable for a requesting device. An approximate location of a requesting device is illustrated and described more fully in relation to FIG. 3 and region 310 corresponding to requesting location 312.

In some examples, group messaging service 112 may utilize a spatial index, such as a SQL spatial index comprised in spatial database 116, in determining the distance between a current location of a requesting computing device and an active location-based group. For example, using SQL spatial geometry objects, indexes may be created based on distances which are used in queries to accurately calculate the distances between locations and corresponding overlaps as described herein with regard to the group messaging service responding to requests to surface one or more active location-based groups. In other examples, group messaging service 112 may simply perform brute force distance calculations to determine the distance between a current location of a requesting computing device and an active location-based group.

Upon identifying one or more active location-based groups for which requesting computing device 120A is determined to be within a discoverability range of (or threshold distance of), group messaging service 112 may cause those one or more active location-based groups to be surfaced on the requesting computing device 120B as illustrated in group surfacing sub-environment 126, and specifically, the user interface element 132 of the group messaging application, which depicts location-based groups G1 through G4 for which the requesting computing device 120A/120B has been determined to be within a discoverability range of.

In some examples, the number of matching groups can be quite large. As such, the matching location-based groups can be caused to be surfaced on the requesting computing device 120B based on distance. By the time a next page of a plurality of active groups is requested by a requesting computing device (e.g., computing device 120A/120B), new groups may have appeared which are closer than the results returned already. The client would generally expect the next page of query results and not a new query. Thus, by taking the time of the first request/query from the requesting computing device 120A into account, the next page of query results may be provided to the requesting computing device 120B without having to maintain what would otherwise be an expensive server-side cache.

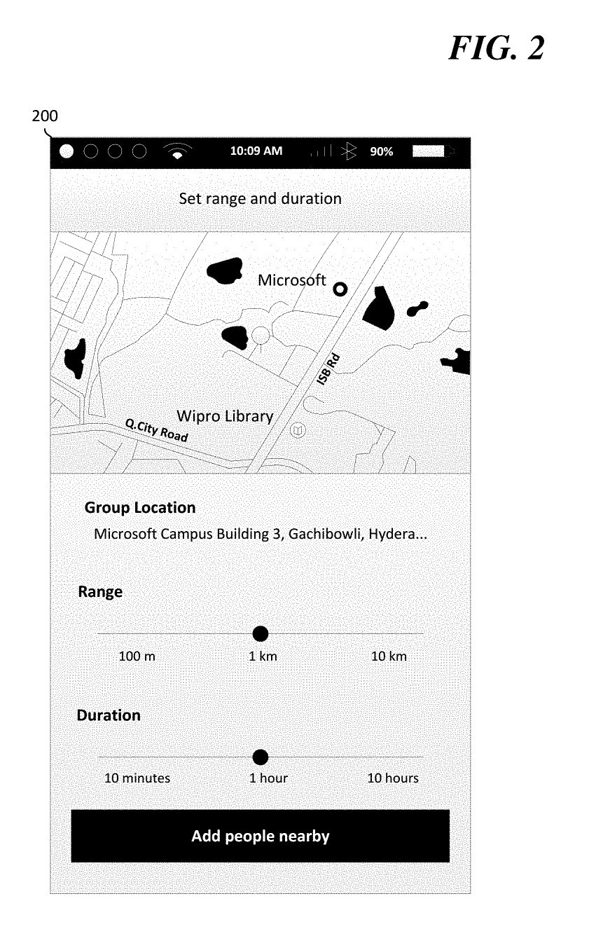

FIG. 2 illustrates an exemplary user interface 200 for creating a location-based group on a group messaging application. User interface 200 comprises a map in its upper portion, and a pin displayed at a location where a user would like to create a location-based group. User interface 200 also includes a “range” bar which a user creating a location-based group may interact with to provide input to the group messaging application to specify a geographic distance from the user's designated group location for which the user would like to allow requesting users to view and/or join the group (i.e., the discoverability range). User interface 200 further comprises a “duration” bar which a user creating a location-based group may interact with to provide input to the group messaging application, and subsequently the group messaging service, to specify a duration that the group will be discoverable for to other users of the group messaging application.

FIG. 3 is a generalized diagram 300 illustrating a user of a group messaging application in relation to a plurality of location-based groups of the group messaging application, each of which may be joinable by the user based on a determined distance between the user's requesting computing device and each group location, and the discoverability range (e.g., radius, distance from a geographic boundary of a geographic indicator) associated with each group.

A user at location 312 has requested, via a requesting computing device executing the group messaging application, that one or more location-based groups for which the user is within a discoverability range of be surfaced on the requesting computing device. In some examples, the longitude and latitude coordinates of the requesting computing device may be provided to the group messaging service, as well as an indication of how accurate the location corresponding to those coordinates is likely to be for the requesting computing device. Based on potential inaccuracy of the location coordinates, the group messaging service may associate a region with the requesting client device's location. This region is illustrated in generalized diagram 300 as region 310. Thus, the region 310 is larger than the actual location 312 corresponding to the longitude and latitude coordinates to account for accuracy issues in location determination as discussed more fully above.

A plurality of active location-based groups that are potentially accessible by the user are included in generalized diagram 300. The plurality of active location-based groups comprises a first location-based group at location 306A, having corresponding discoverability range 306B; second location-based group at location 316A, with corresponding discoverability range 316B; third location-based group at location 304A, with corresponding discoverability range 304B; and fourth location-based group at location 308A, with corresponding discoverability range 308B. Each of the illustrated location-based groups has a designated geographical location point illustrated by the black circle in the center of each of the corresponding discoverability ranges.

The plurality of active location-based groups further comprises fifth location-based group 302, which, unlike the other location-based groups, does not have a designated geographical location point. Rather, fifth location-based group 302 illustrates a group that has been created based on a request to create a group related to a particular geographic indicator and its associated geographic region (e.g., a zip code, a city, a neighborhood, etc.). As such, the discoverability range of fifth location-based group 302 is not circular/radial like the other location-based groups, but rather comprises a boundary corresponding to the geographic region input into the group messaging application that was the basis of its generation/creation.

In this example, the requesting computing device at location 312 would be provided with a surfaced display of the first and second location-based groups, corresponding to locations 306A and 316A, respectively, as well as the fifth location-based group 302. The reason for this is illustrated by the overlap of the region 310, corresponding to the requesting device's approximated location, with each of discoverability ranges 306B and 316B, and the boundary of fifth location-based group 302. Thus, while a distance may have been calculated by the group messaging service between the region 310 (corresponding to the approximate current location of the requesting device) and each of discoverability range 304B (corresponding to third location-based group at location 304A) and discoverability range 308B (corresponding to fourth location-based group at location 308A), neither of those groups would be surfaced to the requesting computing device at location 312 because the determined current approximate location of the requesting device is not within the required discoverability distance range of those groups.

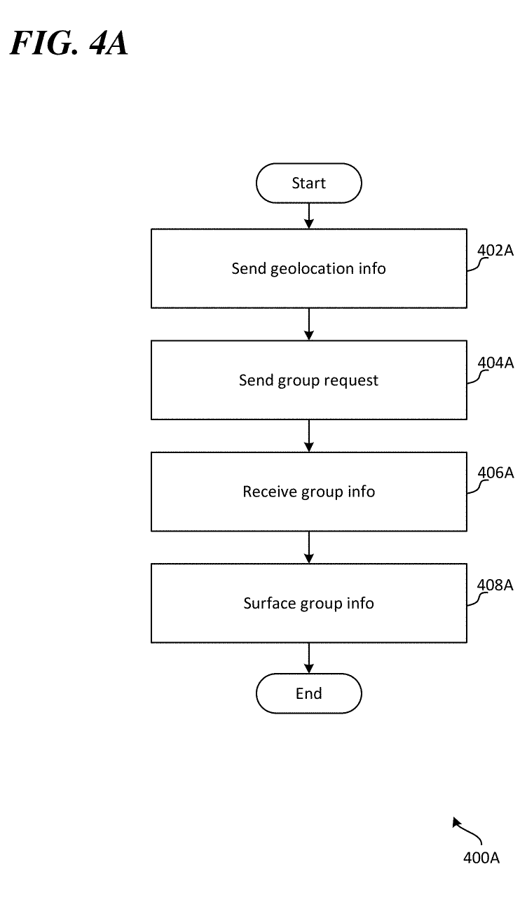

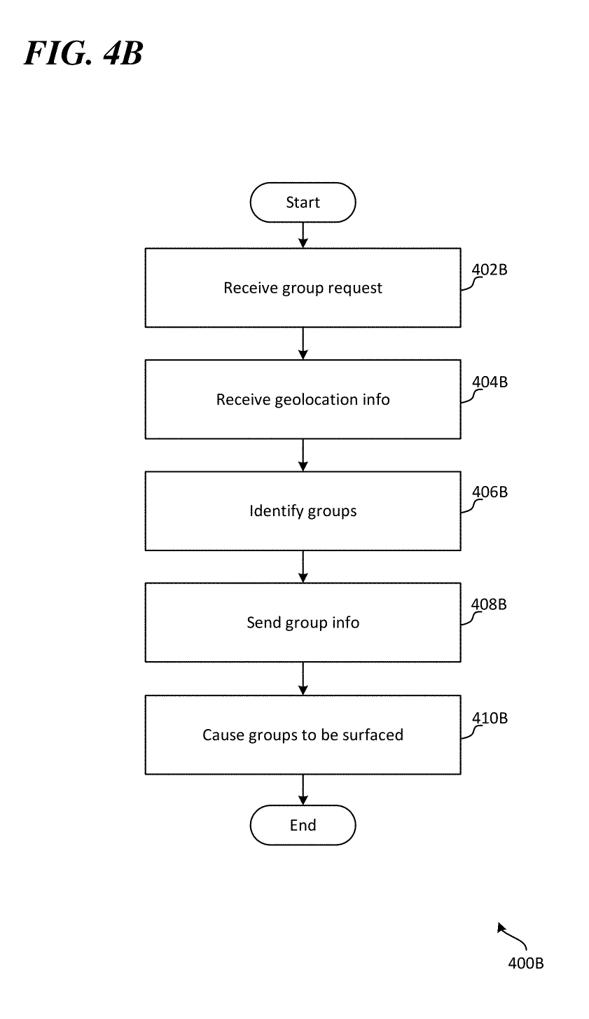

FIG. 4A is an exemplary method 400A for surfacing one or more location-based messaging groups in a group messaging application. The method 400 begins at a start operation and continues to operation 402A where geolocation information associated with a client computing device is sent to a group messaging service. In examples, the geolocation information may comprise longitude and latitude coordinates obtained for the client computing device corresponding to a current location of the client computing device. In some examples, the geolocation associated with the client computing device may be sent to the group messaging service from the client computing device. In other examples, the geolocation may be retrieved from one or more location-based services by the group messaging service.

From operation 402A flow continues to operation 404A where the client computing device sends a request to the group messaging service to surface one or more location-based groups on a user interface of a group messaging application displayed on the client computing device. In some examples, the geolocation information sent to the group messaging service at operation 402A may be comprised in the request to the group messaging service at operation 404A. In other examples, the geolocation information sent to the group messaging service at operation 402A may be sent in a separate communication from the request to the group messaging service at operation 404A. Thus, in some examples, the geolocation information sent to the group messaging service at operation 402A may be provided in a communication that precedes the request to group messaging service at operation 404A. In other examples, the geolocation information sent to the group communication at operation 402A may be provided in a communication contemporaneously with the request to the group messaging service at operation 404A. In still other examples, the geolocation information sent to the group messaging service at operation 402A may be provided in a communication to the group messaging service sent after the request to the group messaging service at operation 404A.

From operation 404A flow continues to operation 406A where information associated with one or more location-based groups, for which a determination has been made that an approximate location of the client computing device is within a discoverability threshold range, is received by the client computing device.

From operation 406A flow continues to operation 408A where a user interface for the group messaging application on the client computing device surfaces the one or more groups for which it has been determined that an approximate location of the client computing device is within a discoverability threshold range.

From operation 408A flow continues to an end operation, and the method 400A ends.

FIG. 4B is an exemplary method 400B for causing one or more location-based messaging groups to be surfaced in a group messaging application. The method 400B begins at a start operation and flow moves to operation 402B where a request is received by a group messaging service to surface one or more location-based groups. The request originates from a client computing device executing a group messaging application. In some examples the request may be manually input into the group messaging application on the client computing device. In other examples the request may be automatically generated by the application, such as being one of a plurality of requests that are sent by the group messaging application to the group messaging service at periodic intervals.

From operation 402B flow continues to operation 404B where the group messaging service receives one or more geolocation indicators associated with a current location of the client computing device from which the request was generated. In examples, the one or more geolocation indicators may comprise longitude and latitude coordinates of the location of the client device, as determined by one or more GPS components associated with the client computing device. In other examples, the one or more geolocation indicators may be determined based on a physical location corresponding to an IP address of a router from which the client computing device's request is sent to the group messaging service. In still other examples, the one or more geolocation indicators may be determined based on triangulation of the client computing device utilizing a plurality of cellular network hubs.

In some examples, in addition to receiving the one or more geolocation indicators, the group messaging service may also receive an indication as to the accuracy of the indicators. That is, the requesting client computing device may provide information with the one or more geolocation indicators that allow the group messaging service to determine the likelihood that the client computing device is at the exact location provided by the one or more geolocation indicators and/or what level of error there may be as to that specified location.

From operation 404B flow continues to operation 406B where one or more location-based groups are identified by the group messaging service for surfacing on a group messaging application user interface of the requesting client computing device. In examples, the group messaging service may make a first determination as to a region corresponding to the client computing device's location, and only select active location-based groups corresponding to that region to make further determinations for with regard to surfacing. In examples, a region for selecting active location-based groups may comprise a radial distance from a requesting client computing device. In other examples, a region for selecting active location-based groups may comprise a city corresponding to the current location of the requesting client computing device, a state corresponding to the current location of the requesting client computing device, a country corresponding to the current location of the requesting client computing device, or any other geographic boundary in which the requesting client computing device is determined to be in based on its current location.

Upon selecting a subset of active location-based groups corresponding to the region of the client computing device's location, the group messaging service may determine the distance between the current location of the client computing device and each of the active location-based groups in the subset. If a determination is made that the calculated distance between a location-based group and the current location of the client computing device is less than the sum of distance of the radius corresponding to a discoverability range for the location-based group plus the distance included to account for margin of error of the client computing device's location, that location-based group meets threshold requirements for surfacing on the requesting client computing device. The query executed by the group messaging service to accomplish this may comprise: “EXECUTE: (Get All entities meeting criterion Distance(point(userLocation), Point(GroupLocation))<Radius+Accuracy))”.

From operation 406B flow continues to operation 408B where information associated with each location-based group of the subset, for which a determination has been made that the threshold requirement for surfacing has been met for the requesting client computing device, is sent from the group messaging service to the requesting client computing device. From operation 408B flow continues to operation 410B where each location-based group of the subset for which the requesting client computing device's location is determined to have met threshold requirements for is caused to be surfaced in the group messaging application UI on the display of the client computing device.

From operation 410B flow continues to an end operation, and the method 400B ends.

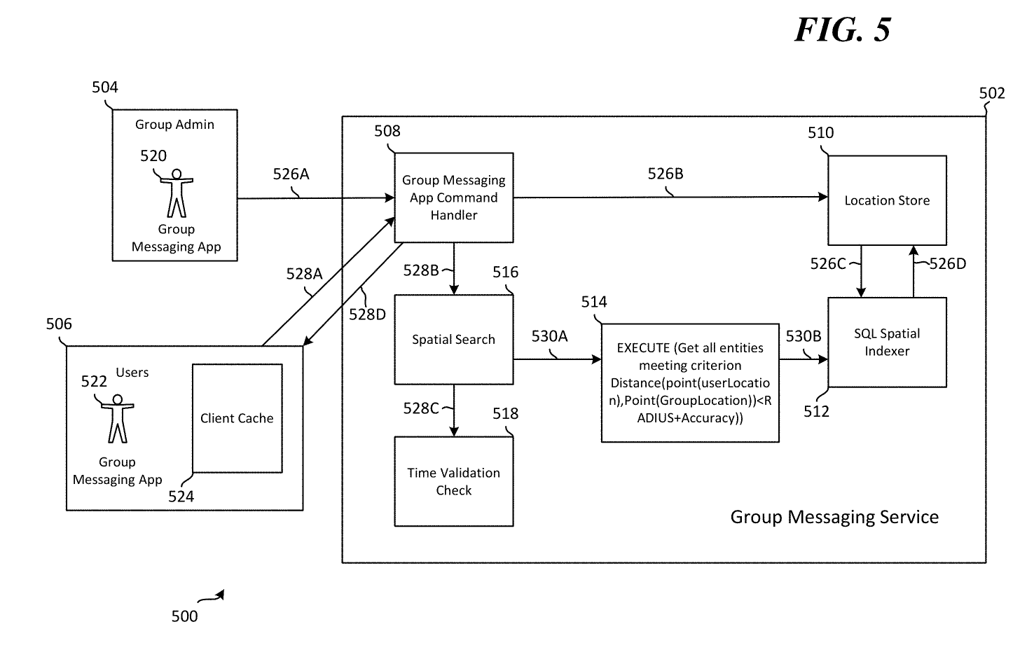

FIG. 5 is a schematic diagram illustrating exemplary components of a distributed computing environment 500 for creating location-based messaging groups for a group messaging application and causing location-based messaging groups to be surfaced based on a requesting client computing device's proximity to each group location and the discoverability range associated with each group.

The schematic diagram 500 includes group creation sub-environment 504, group request sub-environment 506, and group messaging service sub-environment 502. Group creation sub-environment comprises a user 520 that indicates to a client computing device running an instance of a group messaging application that the user 520 would like to create a location-based group. That indication is provided 526A to group messaging service sub-environment 502, and specifically to group messaging application command handler 508. Group messaging application command handler 508 sends 528B the request to spatial search component 516 to identify the correct geolocation corresponding to the information provided by the creating user 520, and the request is further sent 528C to time validation check component 518, which identifies a time specified by the creating user 520 as to the duration that the location-based group being created will remain active for discovery. In identifying the correct geolocation of the group corresponding to the information provided by the creating user 520, the group messaging service may direct 526B the creation request to a location store 510 and further send 526C that request to a SQL spatial indexer 512 for indexing.

Group request sub-environment 506 includes user 522. User 522 makes a request, via a group messaging application on an associated client computing device, to have one or more location-based groups surfaced on the group messaging application user interface of user 522's client computing device. Group request sub-environment 506 also includes client cache 524, which may be utilized in the case that network connection issues interfere with communications between the client computing device and the group messaging service. Thus, if a network connectivity issue exists and the client computing device cannot communicate with the group messaging service, inputs by user 522 to the group messaging application executed on user 522's client computing device may be cached in cache 524, and queued for delivery to the group messaging service upon the network connectivity issues being resolved. Client cache 524 may also store information related to currently active an joinable groups that were received at a time corresponding to a requesting devices request, and in the case that network connection issues exist, the cache may be utilized in updating a displayed list of joinable groups as the user moves, without having to connect to the group messaging service. Thus, even if network connection issues exist, a list of joinable groups may be reordered in the messaging application to reflect the most relevant groups, based on distance, for a device by referring to the client cache 524 as the device/user move through an area with network connection issues. Likewise, if a user is moving through an area with network connectivity issues and a reliable connection to the group messaging service cannot be maintained, a list of joinable groups can be reconfigured, based on information for each group stored in client cache 524, to reflect only those cached groups that are joinable based on the device's current location.

The request to surface one or more location-based groups is sent 528A to group messaging service sub-environment 502, and specifically to group messaging application command handler 508. Group messaging application command handler may send 528B the request to spatial search component 516, as well as sending 528 that request to time validation check component 518 to determine whether one or more location-based groups in the region of the client computing device of the requesting user 522 are active based on a duration of time specified for each location-based group during their creation. The request may also be sent 530A for execution 514 of a query by the group messaging service to determine whether a current location of the requesting client computing device is within a discoverability range of one or more location-based groups in a same region as the client computing device. The query executed in making this determination may comprise: “EXECUTE (Get all entities meeting criterion Distance (Point(userLocation), Point(GroupLocation))<RADIUS+Accuracy”)). In identifying the location point values to use in the query execution, group messaging service may send 530B information associated with the request to the SQL spatial indexer 512, which may communication 526D with location store 510 in identifying the correct location point values corresponding to an approximate current location of the requesting client computing device and the correct location point value corresponding to the location of the location-based group. The SQL spatial indexer 512 may utilize SQL spatial geometry objects to create indexes on distances that are used in the above query to accurately calculate the distances between a requesting client computing device's approximate location and the location of location-based groups, in addition to determining whether a client computing device's approximate location falls within a discoverability threshold distance for location-based groups.

Upon executing the above-described query for each active location-based group in the same region of the requesting client computing device, the group messaging service may send 528D information associated with each matched location-based group for which the client computing device meets the distance criterion, and each matched location-based group may then be caused to be surfaced on the group messaging application user interface on the requesting client computing device.

The advantages provided by systems, methods and devices described herein can be illustrated with respect to a specific example. In this example, if a conference speaker has several hundred delegates present at a location corresponding to the conference speaker's speech, the speaker may utilize the systems, methods and devices described herein to create a location-based group at the conference location through which delegates can post questions, provide feedback and stay in touch after the conference. Previous messaging solutions do not provide a simple and efficient way of doing this. Rather, a user seeking to join a messaging group in this example utilizing previous messaging solutions would need to either input the name of a group in a messaging application corresponding to the conference and perform a manual search to determine whether a messaging group exists for the conference in which they can message other attendees that have joined the messaging group in a like manner, or the user would have to have the contact information for each user at the conference that they would like to send a message to. Additionally, utilizing previous solutions in this example, the number of users in a messaging group for the conference would be limited to only those users that performed the manual search for the group, and subsequently joined the group. In contrast, the group messaging application in association with the group messaging service provided by the systems, methods and devices described herein, would advantageously allow each attendee of the conference to quickly and efficiently join a location-based message group for the conference, by simply opening the group messaging application and requesting through the application to view accessible groups.

Thus, the systems, methods and devices described herein eliminate time consuming steps and their associated processing costs involved with manually searching for a group on a messaging application and/or obtaining individual contact information for each other user that a user would like to message, in addition to increasing the likelihood that users will participate in messaging conversations with one another due to the ease of identifying and joining active location-based groups.

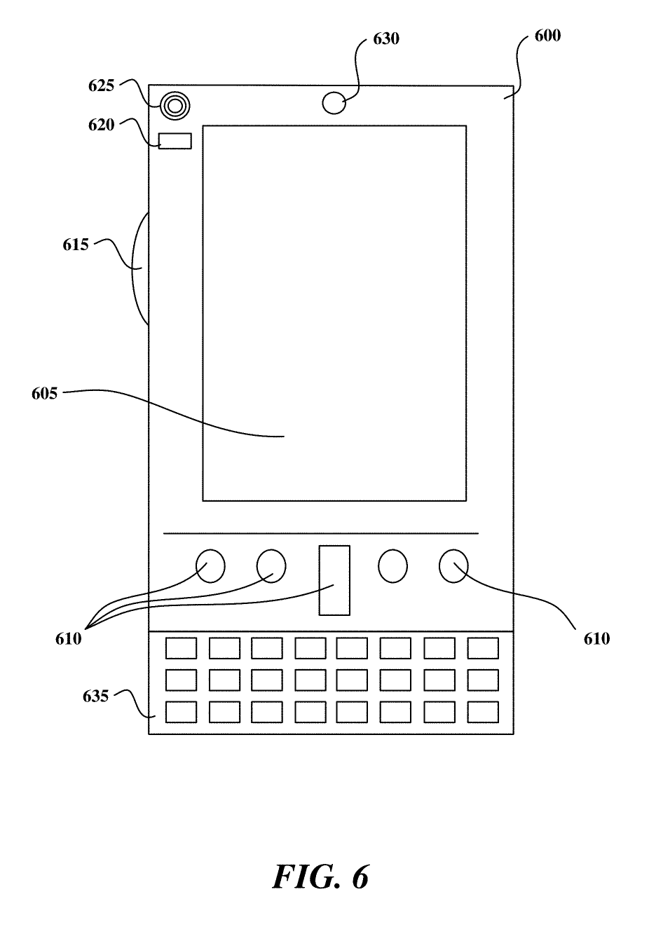

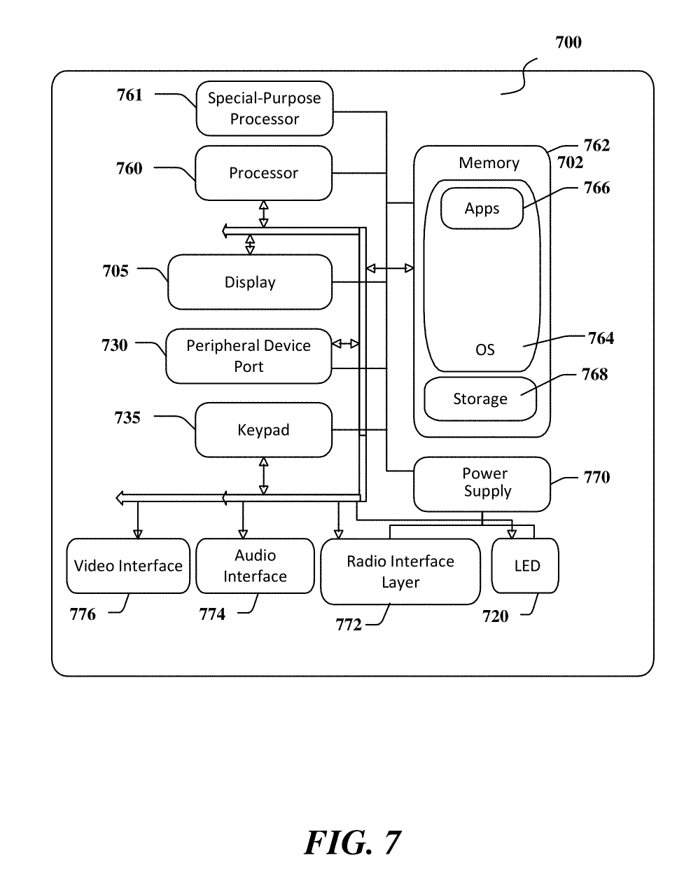

FIGS. 6 and 7 illustrate a mobile computing device 600, for example, a mobile telephone, a smart phone, wearable computer, a tablet computer, an e-reader, and a laptop computer, with which embodiments of the disclosure may be practiced. With reference to FIG. 6, one aspect of a mobile computing device 600 for implementing the aspects is illustrated. In a basic configuration, the mobile computing device 600 is a handheld computer having both input elements and output elements. The mobile computing device 600 typically includes a display 605 and one or more input buttons 610 that allow the user to enter information into the mobile computing device 600. The display 605 of the mobile computing device 600 may also function as an input device (e.g., a touch screen display). If included, an optional side input element 615 allows further user input. The side input element 615 may be a rotary switch, a button, or any other type of manual input element. In alternative aspects, mobile computing device 600 may incorporate more or fewer input elements. For example, the display 605 may not be a touch screen in some embodiments. In yet another alternative embodiment, the mobile computing device 600 is a portable phone system, such as a cellular phone. The mobile computing device 600 may also include an optional keypad 635. Optional keypad 635 may be a physical keypad or a “soft” keypad generated on the touch screen display. In various embodiments, the output elements include the display 605 for showing a graphical user interface (GUI), a visual indicator 620 (e.g., a light emitting diode), and/or an audio transducer 625 (e.g., a speaker). In some aspects, the mobile computing device 600 incorporates a vibration transducer for providing the user with tactile feedback. In yet another aspect, the mobile computing device 600 incorporates input and/or output ports, such as an audio input (e.g., a microphone jack), an audio output (e.g., a headphone jack), and a video output (e.g., a HDMI port) for sending signals to or receiving signals from an external device.

FIG. 7 is a block diagram illustrating the architecture of one aspect of a mobile computing device. That is, the mobile computing device 700 can incorporate a system (e.g., an architecture) 702 to implement some aspects. In one embodiment, the system 702 is implemented as a “smart phone” capable of running one or more applications (e.g., browser, e-mail, calendaring, contact managers, messaging clients, games, and media clients/players). In some aspects, the system 702 is integrated as a computing device, such as an integrated personal digital assistant (PDA) and wireless phone.

One or more application programs 766 may be loaded into the memory 762 and run on or in association with the operating system 764. Examples of the application programs include phone dialer programs, e-mail programs, personal information management (PIM) programs, word processing programs, spreadsheet programs, Internet browser programs, messaging programs, and so forth. The system 702 also includes a non-volatile storage area 768 within the memory 762. The non-volatile storage area 768 may be used to store persistent information that should not be lost if the system 702 is powered down. The application programs 766 may use and store information in the non-volatile storage area 768, such as e-mail or other messages used by an e-mail application, and the like. A synchronization application (not shown) also resides on the system 702 and is programmed to interact with a corresponding synchronization application resident on a host computer to keep the information stored in the non-volatile storage area 768 synchronized with corresponding information stored at the host computer. As should be appreciated, other applications may be loaded into the memory 762 and run on the mobile computing device 700, including instructions for identifying and surfacing one or more location-based groups in response to a group messaging application request for the same.

The system 702 has a power supply 770, which may be implemented as one or more batteries. The power supply 770 might further include an external power source, such as an AC adapter or a powered docking cradle that supplements or recharges the batteries.

The system 702 may also include a radio interface layer 772 that performs the function of transmitting and receiving radio frequency communications. The radio interface layer 772 facilitates wireless connectivity between the system 702 and the “outside world,” via a communications carrier or service provider. Transmissions to and from the radio interface layer 772 are conducted under control of the operating system 764. In other words, communications received by the radio interface layer 772 may be disseminated to the application programs 766 via the operating system 764, and vice versa.

The visual indicator 620 may be used to provide visual notifications, and/or an audio interface 774 may be used for producing audible notifications via the audio transducer 625. In the illustrated embodiment, the visual indicator 620 is a light emitting diode (LED) and the audio transducer 625 is a speaker. These devices may be directly coupled to the power supply 770 so that when activated, they remain on for a duration dictated by the notification mechanism even though the processor 760 and other components might shut down for conserving battery power. The LED may be programmed to remain on indefinitely until the user takes action to indicate the powered-on status of the device. The audio interface 774 is used to provide audible signals to and receive audible signals from the user. For example, in addition to being coupled to the audio transducer 625, the audio interface 774 may also be coupled to a microphone to receive audible input, such as to facilitate a telephone conversation. In accordance with embodiments of the present disclosure, the microphone may also serve as an audio sensor to facilitate control of notifications, as will be described below. The system 702 may further include a video interface 776 that enables an operation of an on-board camera 630 to record still images, video stream, and the like.

A mobile computing device 700 implementing the system 702 may have additional features or functionality. For example, the mobile computing device 700 may also include additional data storage devices (removable and/or non-removable) such as, magnetic disks, optical disks, or tape. Such additional storage is illustrated in FIG. 7 by the non-volatile storage area 768.

Data/information generated or captured by the mobile computing device 700 and stored via the system 702 may be stored locally on the mobile computing device 700, as described above, or the data may be stored on any number of storage media that may be accessed by the device via the radio interface layer 772 or via a wired connection between the mobile computing device 700 and a separate computing device associated with the mobile computing device 700, for example, a server computer in a distributed computing network, such as the Internet. As should be appreciated such data/information may be accessed via the mobile computing device 700 via the radio interface layer 772 or via a distributed computing network. Similarly, such data/information may be readily transferred between computing devices for storage and use according to well-known data/information transfer and storage means, including electronic mail and collaborative data/information sharing systems.

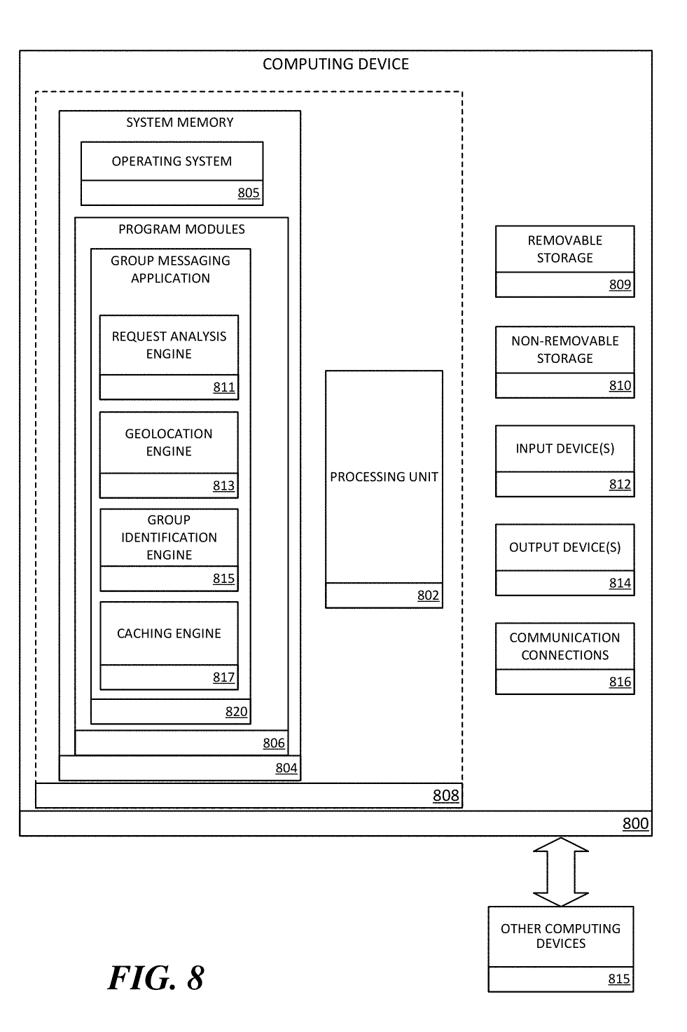

FIG. 8 is a block diagram illustrating physical components (e.g., hardware) of a computing device 800 with which aspects of the disclosure may be practiced. The computing device components described below may have computer executable instructions for creating location-based groups associated with a group messaging application, and causing one or more location-based groups to be surfaced in the group messaging application based on a user's proximity to each group location and the discoverability range associated with each group. In a basic configuration, the computing device 800 may include at least one processing unit 802 and a system memory 804. Depending on the configuration and type of computing device, the system memory 804 may comprise, but is not limited to, volatile storage (e.g., random access memory), non-volatile storage (e.g., read-only memory), flash memory, or any combination of such memories. The system memory 804 may include an operating system 805 suitable for running one or more group messaging programs. The operating system 805, for example, may be suitable for controlling the operation of the computing device 800. Furthermore, embodiments of the disclosure may be practiced in conjunction with a graphics library, other operating systems, or any other application program and is not limited to any particular application or system. This basic configuration is illustrated in FIG. 8 by those components within a dashed line 808. The computing device 800 may have additional features or functionality. For example, the computing device 800 may also include additional data storage devices (removable and/or non-removable) such as, for example, magnetic disks, optical disks, or tape. Such additional storage is illustrated in FIG. 8 by a removable storage device 809 and a non-removable storage device 810.

As stated above, a number of program modules and data files may be stored in the system memory 804. While executing on the processing unit 802, the program modules 806 (e.g., group messaging application 820, request analysis engine 811, geolocation engine 813, group identification engine 815, and caching engine 817) may perform processes including, but not limited to, the aspects, as described herein. According to examples, the request analysis engine 811 may perform one or more operations associated with analyzing group messaging application requests to surface one or more location-based groups. Geolocation engine 813 may perform one or more operations associated with determining the distance between a requesting client device and one or more location-based groups. Group identification engine 815 may perform one or more operations associated with determining whether a requesting device is within a threshold distance of one or more location-based groups in relation to each location-based group's location and discoverability range. Caching engine 817 may perform one or more operations associated with caching geolocation information of a client device, caching information associated with location-based groups that were determined to be available for joining by requesting devices, caching requests to a group messaging service, and forwarding cached requests that are initially undeliverable due to network issues and the like.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 8 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 800 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

The computing device 800 may also have one or more input device(s) 812 such as a keyboard, a mouse, a pen, a sound or voice input device, a touch or swipe input device, etc. The output device(s) 814 such as a display, speakers, a printer, etc. may also be included. The aforementioned devices are examples and others may be used. The computing device 800 may include one or more communication connections 816 allowing communications with other computing devices 815. Examples of suitable communication connections 816 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 804, the removable storage device 809, and the non-removable storage device 810 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 800. Any such computer storage media may be part of the computing device 800. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

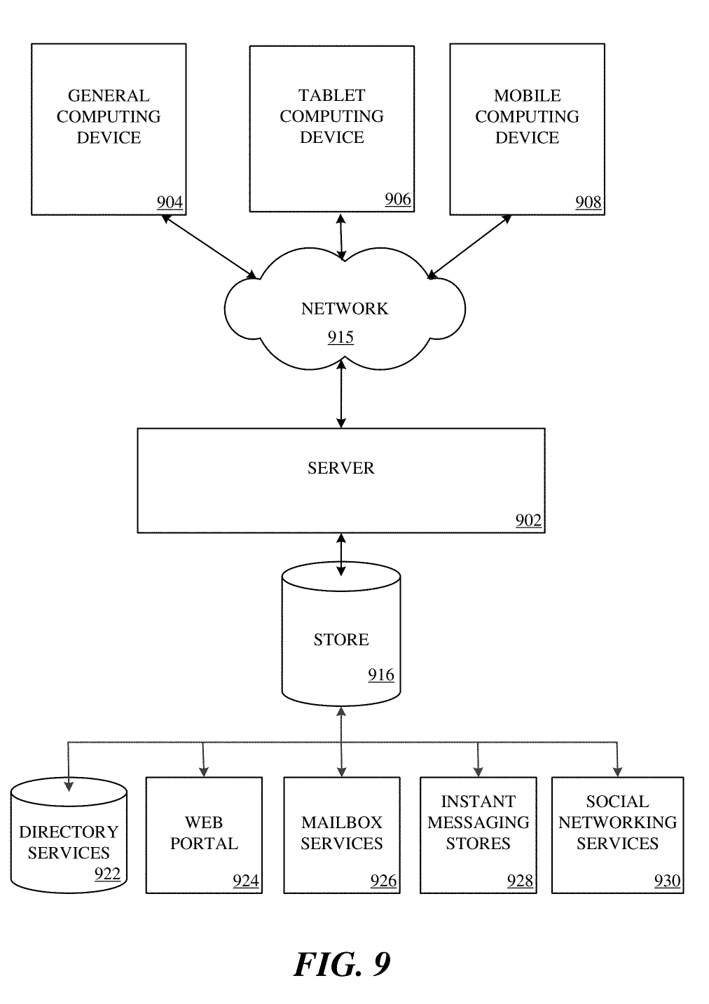

FIG. 9 illustrates one aspect of the architecture of a system for processing data received at a computing system from a remote source, such as a personal/general computer 904, tablet computing device 906, or mobile computing device 908, as described above. Content displayed at server device 902 may be stored in different communication channels or other storage types. For example, various documents may be stored using a directory service 922, a web portal 924, a mailbox service 926, an instant messaging store 928, or a social networking site 930. The program modules 806 may be employed by a client that communicates with server device 902, and/or the program modules 806 may be employed by server device 902. The server device 902 may provide data to and from a client computing device such as a personal/general computer 904, a tablet computing device 906 and/or a mobile computing device 908 (e.g., a smart phone) through a network 915. By way of example, the computer system described above with respect to FIGS. 6-8 may be embodied in a personal/general computer 904, a tablet computing device 906 and/or a mobile computing device 908 (e.g., a smart phone). Any of these embodiments of the computing devices may obtain content from the store 916, in addition to receiving graphical data useable to be either pre-processed at a graphic-originating system, or post-processed at a receiving computing system.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present disclosure, one skilled in the art may envision variations, modifications, and alternate aspects falling within the spirit of the broader aspects of the general inventive concept embodied in this application that do not depart from the broader scope of the claimed disclosure.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

What is claimed is:

1. A method for surfacing one or more location-based messaging groups, the method comprising:
sending geolocation information associated with a location of a client computing device to a group messaging service;
sending, from a group messaging application to the group messaging service, a request to identify one or more location-based messaging groups accessible by the client computing device based, at least in part, on the location of the client computing device;
receiving, from the group messaging service, information associated with one or more location-based messaging groups for which the location of the client computing device meets a location-based surfacing threshold; and
surfacing, on a display of the client computing device, the one or more location-based messaging groups for which the location of the client computing device meets the location-based surfacing threshold.

2. The method of claim 1, wherein the accessibility of the one or more location-based messaging groups is further based on a geographic region corresponding to a geographic indicator that the location of the client computing device is determined to be in based on the geolocation associated with the location of the client computing device sent to the group messaging service.

3. The method of claim 2, wherein the geographic indicator comprises one of: a building, a city, a neighborhood, and a postal code.

4. The method of claim 2, wherein the geographic indicator is determined based on longitude and latitude coordinates corresponding to the location of the client computing device.

5. The method of claim 4, wherein the geographic region is determined based on matching, by the group messaging service in association with a geolocation service, the geolocation associated with the location of the client computing device to the geographic indicator.

6. The method of claim 1, further comprising:
caching, on the client computing device, information associated with each of the one or more location-based messaging groups for which the location of the client computing device meets the location-based surfacing threshold.

7. The method of claim 6, further comprising:
determining that the client computing device cannot reach the group messaging service;
determining that the client computing device is in a new location different than the location sent to the group messaging service; and
updating, based on the client computing device's new location and the cached information associated with each of the one or more location-based groups, a listing of the one or more location-based messaging groups on the display of the client computing device.

8. The method of claim 7, wherein the updating comprises removing each of the one or more location-based messaging groups from the listing for which the new location of the client computing device no longer meets a location-based surfacing threshold.

9. A system for creating one or more location-based messaging groups, the system comprising:
a memory for storing executable program code; and
one or more processors, functionally coupled to the memory, the one or more processors being responsive to computer-executable instructions contained in the program code and operative to:
receive, from a group messaging application, a request to create a location-based messaging group, wherein the request comprises a geographic location;
determining geographic coordinates corresponding to the geographic location;
identify, based on the geographic coordinates, a plurality of geographic indicators that the geographic coordinates correspond to;
receive, from the group messaging application, a selection of at least one of the geographic indicators; and
create the location-based messaging group.

10. The system of claim 9, wherein the one or more processors are further responsive to the computer-executable instructions contained in the program code and operative to:
receive, from a requesting client computing device, a request to surface at least one location-based messaging group on a display of the requesting client computing device, wherein the request comprises a current location of the client computing device;
determine a plurality of geographic indicators corresponding to the received current location of the client computing device; and
if at least one of the plurality of geographic indicators corresponding to the received current location of the client computing device is a same geographic indicator as one of the selected geographic indicators, cause the created location-based messaging group to be displayed.

11. The system of claim 9, wherein the request further comprises a range from a geographic boundary corresponding to each of the at least one selected geographic indicators that the location-based message group will be accessible to requesting devices.

12. The system of claim 10, wherein the location-based messaging group is accessible by client devices that are determined to be in a geographic region corresponding to the selected geographic indicators.

13. The system of claim 9, wherein the request further comprises a duration that the location-based messaging group is to be active.

14. The system of claim 9, wherein each of the plurality of geographic indicators comprises one of: a country, a city, a neighborhood, a geographic region, and a postal code.

15. The system of claim 9, wherein the request is received from a group messaging application account that is an administration account for an enterprise associated with a plurality of enterprise locations.

16. The system of claim 15, wherein the one or more processors are further responsive to the computer-executable instructions contained in the program code and operative to:
determine that the geographic location included in the request corresponds to at least one of the plurality of enterprise locations; and
create, based on the request, a location-based group corresponding to the request for each of the plurality of enterprise locations that correspond to the geographic location included in the request.

17. A computer-readable storage device comprising executable instructions that, when executed by one or more processors, assists with surfacing one or more location-based messaging groups, the computer-readable storage device including instructions executable by the one or more processors for:
sending geolocation information associated with a location of a client computing device to a group messaging service;
sending, to the group messaging service, a request to identify one or more location-based messaging groups accessible by the client computing device based, at least in part, on the location of the client computing device;
receiving, from the group messaging service, information associated with one or more location-based messaging groups for which the location of the client computing device meets a location-based surfacing threshold; and
surfacing, on a display of the client computing device, the one or more location-based messaging groups for which the location of the client computing device meets the location-based surfacing threshold.

18. The computer-readable storage device of claim 17, wherein the instructions are further executable by the one or more processors for:
caching, on the client computing device, information associated with each of the one or more location-based messaging groups for which the location of the client computing device meets the location-based surfacing threshold.

19. The computer-readable storage device of claim 18, wherein the instructions are further executable by the one or more processors for:
determining that the client computing device cannot reach the group messaging service;
determining that the client computing device is in a new location different than the location sent to the group messaging service; and
updating, based on the client computing device's new location and the cached information associated with each of the one or more location-based groups, a listing of the one or more location-based messaging groups on the display of the client computing device.

20. The computer-readable storage device of claim 19, wherein the updating comprises removing each of the one or more location-based messaging groups from the listing for which the new location of the client computing device no longer meets a location-based surfacing threshold.
